(19) United States
(12) Patent Application Publication
(10) Pub. No.: US 2008/0085344 A1
(43) Pub. Date: Apr. 10, 2008

(54) COMPOSITION INCLUDING ORANGE JUICE AND AN ADDED MULTI-VITAMIN AND MINERAL COMPONENT

(75) Inventors: Karen Williams, Winter Garden, FL (US); Sonhee Park, Apopka, FL (US); Donald Striegel, Clermont, FL (US); Susan Roberts, Atlanta, GA (US)

Correspondence Address: MORRISON & FOERSTER LLP, 1650 TYSONS BOULEVARD, SUITE 400, MCLEAN, VA, 22102, US

(73) Assignee: The Coca-Cola Company, Atlanta, GA (US)

(21) Appl. No.: 11/868,101

(22) Filed: Oct. 5, 2007

Related U.S. Application Data
(60) Provisional application No. 60/849,458, filed on Oct. 5, 2006.

(51) Int. Cl. A23L 1/303; A23L 1/302; A23L 1/304; A23L 2/02

(52) U.S. Cl. 426/73; 426/599; 426/72; 426/74

(57) ABSTRACT

An orange juice beverage composition comprising orange juice and an added multivitamin and mineral component. The orange juice composition of the invention provides a delicious and refreshing way to give the body important vitamins and minerals for good health.

### BACKGROUND OF THE INVENTION

This invention relates to the field of orange juice, particularly a composition containing orange juice and an added multi-vitamin and mineral component.

Current dietary guidelines (2005) recommend that people consume five servings of fruits and vegetables a day for a 2000 calorie diet, but many people fall short of this recommendation. A way to get the recommended servings for fruit is to start the day with orange juice

In addition, consistent use of multi-vitamins and minerals can promote good health and help prevent disease. In general, a good daily multi-vitamin improves overall bodily functioning and boosts both physical and mental health and well-being. A multi-vitamin and mineral supplement usually contains the recommended daily dose of a variety of vitamins and other nutrients.

### BRIEF SUMMARY OF THE INVENTION

It is an object of the invention to provide a composition comprising orange juice supplemented with a multi-vitamin and mineral component, where the added multi-vitamin and mineral component may include at least one of Beta Carotene, Vitamin B5, Vitamin B3, Vitamin B6, Vitamin B2, Vitamin B12, Vitamin D3, Vitamin E, Chromium, Copper, Magnesium, Manganese, Selenium, and Zinc.

### DETAILED DESCRIPTION OF THE INVENTION

Although both orange juice and multi-vitamins and minerals are known for being beneficial to your health, many people forego one or the other or both. However, those who already enjoy orange juice as part of their daily routine would also appreciate the known benefits of additional multi-vitamins and minerals as well.

The benefits of the vitamins and minerals in a multi-vitamin are well known. An example of one such beneficial mineral is selenium, which is thought to reduce the risk of cancer in several organs. In recent years, laboratory experiments, clinical trials and epidemiological data have established the role of selenium in the prevention of a number of degenerative conditions including cancer, inflammatory diseases, cardiovascular disease, neurological diseases, aging, and infections.

A study at the University of Arizona in Tucson in 1996 found that people who took 200 mcg of selenium a day for four and a half years reduced their risk of cancer by 32 percent and their risk of death from cancer by 50 percent. Further, numerous research reports indicate that higher blood levels of selenium is associated with lower incidence and mortality from cancer including lung, colorectal and prostate cancer.

People are often reluctant to take a pill every day, or have difficulty swallowing what is often times a large pill. However, many people enjoy the sweet and refreshing taste of orange juice as a way to start their day. Therefore, it would be advantageous to combine the benefits of an added multi-vitamin and mineral with the great taste of orange juice so that people can enjoy the healthful benefits of both the orange juice and the multi-vitamin without the burden of remembering to take a vitamin every day or without the unpleasant experience of swallowing a pill which may have an unpleasant taste or smell.

The composition including orange juice and an added multi-vitamin and mineral component of the invention is formulated to provide the benefits of a multi-vitamin, but without the added step of taking a multi-vitamin pill. The multi-vitamin and mineral component added to the composition may contain one or more of the following: Beta Carotene, Vitamin B5, Vitamin B3, Vitamin B6, Vitamin B2, Vitamin B12, Vitamin D3, Vitamin E, Chromium, Copper, Magnesium, Manganese, Selenium, and Zinc.

According to a preferred embodiment of the invention, a composition including orange juice and an added multi-vitamin and mineral component is provided. The added multi-vitamin and mineral component according to this embodiment may contain one or more of the following per eight fluid ounce serving of the composition: Beta Carotene in an amount per serving between 100-1500 IU, Vitamin B5 in an amount per serving between 0.2-3 mg, Vitamin B3 in an amount per serving between 0.4-6 mg, Vitamin B6 in an amount per serving between 0.04-0.6 mg, Vitamin B2 in an amount per serving between 0.034-0.51 mg, Vitamin B12 in an amount per serving between 0.12-1.8 mg, Vitamin D3 in an amount per serving between 8-120 IU, Vitamin E in an amount per serving between 0.6-9 IU, Chromium in an amount per serving between 2.4-36 mcg, Copper in an amount per serving between 0.04-0.6 mg, Magnesium in an amount per serving between 8-120 mg, Manganese in an amount per serving between 0.04-0.6 mg, Selenium in an amount per serving between 1.4-21 mcg, and Zinc in an amount per serving between 0.3-4.5 mg.

According to a more preferred embodiment of the invention, a composition including orange juice and an added multi-vitamin and mineral component is provided. The added multi-vitamin and mineral component according to this embodiment may contain one or more of the following per eight fluid ounce serving of the composition: Beta Carotene in an amount between −500-1250 IU, Vitamin B5 in an amount per serving between 1.0-2.5 mg, Vitamin B3 in an amount per serving between 2-5 mg, Vitamin B6 in an amount per serving between 0.2-0.5 mg, Vitamin B2 in an amount per serving between 0.17-0.4 mg, Vitamin B 12 in an amount per serving between 0.6-1.5 mg, Vitamin D3 in an amount per serving between 40-100 IU, Vitamin E in an amount per serving between 3-7.5 IU, Chromium in an amount per serving between 12-30 mcg, Copper in an amount per serving between 0.2-0.5 mg, Magnesium in an amount per serving between 20-80 mg, Manganese in an amount per serving between 0.2-0.5 mg, Selenium in an amount per serving between 7-17.5 mcg, and Zinc in an amount per serving between 1.5-3.8 mg.

According to the preferred embodiment of the invention, the added multi-vitamin and mineral component may include at least one of the following per eight fluid ounce serving: beta carotene in an amount between 100 and 1500 IU or between 0.66 and 9.87 mg as a beta carotene source; D-calcium pantothenate in an amount per eight ounce serving between 0.27 and 4.09 mg providing between 0.2 and 3 mg of Vitamin B5; niacinamide in an amount per eight ounce serving between 0.44 and 6.64 mg providing between 0.4 and 6 mg of Vitamin B3; pyridoxine hydrochloride in an amount per eight ounce serving between 0.05 and 0.799 mg providing between 0.04 and 0.6 mg of Vitamin B6; riboflavin in an amount per eight ounce serving between 0.04 and 0.582 mg providing between 0.034 and 0.51 mg of Vitamin B2; cyanocobalamin in an amount per eight ounce serving between 0.12 and 1.8 mg supplied through a complex between 0.15 and 2.26 mg; cholecalciferol in an amount per eight ounce serving between 8 and 120 IU supplied through a complex between 0.08 and 1.2 mg; tocopheryl acetate in an amount per eight ounce serving between 0.6 and 9 IU or between 1.2 and 18 mg as a 50% Vitamin E complex; chromium in an amount per eight ounce serving between 2.4 and 36 mcg or between 0.24 and 3.6 mg as chromium picolinate; copper in an amount per eight ounce serving between 0.04 and 0.6 mg or between 0.29 and 4.29 mg as Copper Gluconate; magnesium in an amount per eight ounce serving between 8 and 120 mg or between 59.6 and 894 mg as Magnesium Phosphate; Manganese in an amount per eight ounce serving between 0.04 and 0.6 mg or between 0.123 and 1.845 mg as Manganese Sulfate; Selenium in an amount per eight ounce serving between 1.4 and 21 mcg or between 0.0034 and 0.051 mg as sodium Selenate; zinc in an amount per eight ounce serving between 0.3 and 4.5 mg or between 2.33 and 35 mg as Zinc Gluconate; and maltodextrin in a minor amount per eight ounce serving. The weight of each source of this embodiment may include overages for shelf stability and concentration of nutrient in source form used.

According to the more preferred embodiment of the invention, the added multi-vitamin and mineral component may include at least one of the following per eight fluid ounce serving: beta carotene in an amount per eight ounce serving between 500 and 1250 IU or between 3.29 and 8.225 mg as a beta carotene source; D-calcium pantothenate in an amount per eight ounce serving between 1.36 and 3.41 mg providing between 1 and 2.5 mg of Vitamin B5; niacinamide in an amount per eight ounce serving between 2.21 and 5.53 mg providing between 2 and 5 mg of Vitamin B3; pyridoxine hydrochloride in an amount per eight ounce serving between 0.27 and 0.666 mg providing between 0.2 and 0.5 mg of Vitamin B6; riboflavin in an amount per eight ounce serving between 0.19 and 0.485 mg providing between 0.17 and 0.4 mg of Vitamin B2; cyanocobalamin in an amount per eight ounce serving between 0.6 and 1.5 mg supplied through a complex between 0.75 and 1.88 mg; cholecalciferol in an amount per eight ounce serving between 40 and 100 IU or between 0.4 and 1 mg supplied through a complex; tocopheryl acetate in an amount per eight ounce serving between 3 and 7.5 IU or between 6 and 15 mg as a 50% Vitamin E complex; chromium in an amount per eight ounce serving between 12 and 30 mcg or between 1.2 and 3 mg as chromium picolinate; copper in an amount per eight ounce serving between 0.2 and 0.5 mg or between 1.43 and 3.575 mg as Copper Gluconate; Magnesium in an amount per eight ounce serving between 20 and 80 mg or between 149 and 596 mg as Magnesium Phosphate; Manganese in an amount per eight ounce serving between 0.2 and 0.5 mg or between 0.615 and 1.5375 mg as Manganese Sulfate; Selenium in an amount per eight ounce serving between 7 and 17.5 mcg or between 0.017 and 0.0425 mg as sodium Selenate; zinc in an amount per eight ounce serving between 1.5 and 3.8 mg or between 11.67 and 29.17 mg as Zinc Gluconate; and maltodextrin in a minor amount per eight ounce serving. The weight of each source of this embodiment may include overages for shelf stability and concentration of nutrient in source form used.

Although the vitamins and minerals have been listed with their preferred sources, it should be understood to those of ordinary skill in the art that there are other sources of such vitamins and minerals which would be suitable for use with the composition including orange juice and an added multi-vitamin and mineral component.

The following table, Table 1, lists a preferred range of each of the ingredients (per eight ounce serving of the beverage) of the added multi-vitamin and mineral component of the composition according to a preferred embodiment of the invention.

TABLE 1
Multi-vitamin and mineral levels added to orange juice plus
multi-vitamin and mineral composition (per 8 fl. Oz)

| INGREDIENTS | Preferred Range | |
|---|---|---|
| Beta Carotene | 100-1500 | IU |
| Vitamin B5 | 0.2-3 | mg |
| Vitamin B3 | 0.4-6 | mg |
| Vitamin B6 | 0.04-0.6 | mg |
| Vitamin B2 | 0.034-0.51 | mg |
| Manganese | 0.04-0.6 | mg |
| Vitamin B12 | 0.12-1.8 | mg |
| Vitamin D3 | 8-120 | IU |
| Vitamin E | 0.6-9 | IU |
| Chromium | 2.4-36 | mcg |
| Copper | 0.04-0.6 | mg |
| Magnesium | 8-120 | mg |
| Selenium | 1.4-21 | mcg |
| Zinc | 0.3-4.5 | mg |

The following table, Table 2, lists a more preferred range of each of the ingredients (per eight ounce serving of the beverage) of the added multi-vitamin and mineral component of the composition according to a more preferred embodiment of the invention.

TABLE 2
Multi-vitamin and mineral levels added to orange juice plus
multi-vitamin and mineral composition (per 8 fl. Oz)

| INGREDIENTS | More Preferred Range | |
|---|---|---|
| Beta Carotene | 500-1250 | IU |
| Vitamin B5 | 1.0-2.5 | mg |
| Vitamin B3 | 2-5 | mg |
| Vitamin B6 | 0.2-0.5 | mg |
| Vitamin B2 | 0.17-0.4 | mg |
| Manganese | 0.2-0.5 | mg, |
| Vitamin B12 | 0.6-1.5 | mg, |
| Vitamin D3 | 40-100 | IU |
| Vitamin E | 3-7.5 | IU |
| Chromium | 12-30 | mcg |
| Copper | 0.2-0.5 | mg |
| Magnesium | 20-80 | mg |
| Selenium | 7-17.5 | mcg |
| Zinc | 1.5-3.8 | mg |

The foregoing is not intended to limit the invention, but is instead intended to merely describe particular embodiments within the scope of the invention as defined by the claims. The claims are intended to be construed according to their ordinary meaning, and nothing in this specification is intended to prescribe a narrower meaning to any claim term.

What is claimed is:

1. A composition comprising orange juice supplemented with a selenium component where the selenium is provided by sodium selenate.

2. A composition comprising orange juice supplemented with a multi-vitamin and mineral component, where the added multi-vitamin and mineral component includes at least one of Beta Carotene, Vitamin B5, Vitamin B3, Vitamin B6, Vitamin B2, Vitamin B12, Vitamin D3, Vitamin E, Chromium, Copper, Magnesium, Manganese, Selenium, and Zinc.

3. A composition comprising orange juice supplemented with a multi-vitamin and mineral component, where the added multi-vitamin and mineral component includes at least one of Beta Carotene in an amount of between 500-1250 IU per eight ounce fluid serving, Vitamin B5 in an amount of between 1.0-2.5 mg per eight ounce fluid serving, Vitamin B3 in an amount of between 2-5 mg per eight fluid ounce serving, Vitamin B6 in an amount of between 0.2-0.5 mg per eight fluid ounce serving, Vitamin B2 in an amount of between 0.17-0.4 mg per eight fluid ounce serving, Vitamin B12 in an amount of between 0.6-1.5 mg per eight fluid ounce serving, Vitamin D3 in an amount of between 40-100 IU per eight fluid ounce serving, Vitamin E in an amount of between 3-7.5 IU per eight fluid ounce serving, Chromium in an amount per of between 12-30 mcg per eight fluid ounce serving, Copper in an amount of between 0.2-0.5 mg per eight fluid ounce serving, Magnesium in an amount of between 20-80 mg per eight fluid ounce serving, Manganese in an amount of between 0.2-0.5 mg per eight fluid ounce serving, Selenium in an amount of between 7-17.5 mcg per eight fluid ounce serving, and Zinc in an amount of between −1.5-3.8 mg per eight fluid ounce serving.

4. A composition comprising orange juice supplemented with a multi-vitamin and mineral component, where the added multi-vitamin and mineral component includes Beta Carotene in an amount of between 500-1250 IU per eight ounce fluid serving, Vitamin B5 in an amount of between 1.0-2.5 mg per eight ounce fluid serving, Vitamin B3 in an amount of between 2-5 mg per eight fluid ounce serving, Vitamin B6 in an amount of between 0.2-0.5 mg per eight fluid ounce serving, Vitamin B2 in an amount of between 0.17-0.4 mg per eight fluid ounce serving, Vitamin B12 in an amount of between 0.6-1.5 mg per eight fluid ounce serving, Vitamin D3 in an amount of between 40-100 IU per eight fluid ounce serving, Vitamin E in an amount of between 3-7.5 IU per eight fluid ounce serving, Chromium in an amount per of between 12-30 mcg per eight fluid ounce serving, Copper in an amount of between 0.2-0.5 mg per eight fluid ounce serving, Magnesium in an amount of between 20-80 mg per eight fluid ounce serving, Manganese in an amount of between 0.2-0.5 mg per eight fluid ounce serving, Selenium in an amount of between 7-17.5 mcg per eight fluid ounce serving, and Zinc in an amount of between 1.5-3.8 mg per eight fluid ounce serving.

5. A composition comprising orange juice supplemented with a multi-vitamin and mineral component, where the added multi-vitamin and mineral component may include at least one of the following per eight fluid ounce serving: beta carotene in an amount per eight ounce serving between 500 and 1250 IU or between 3.29 and 8.225 mg as a beta carotene source; D-calcium pantothenate in an amount per eight ounce serving between 1.36 and 3.41 mg providing between 1 and 2.5 mg of Vitamin B5; niacinamide in an amount per eight ounce serving between 2.21 and 5.53 mg providing between 2 and 5 mg of Vitamin B3; pyridoxine hydrochloride in an amount per eight ounce serving between 0.27 and 0.666 mg providing between 0.2 and 0.5 mg of Vitamin B6; riboflavin in an amount per eight ounce serving between 0.19 and 0.485 mg providing between 0.17 and 0.4 mg of Vitamin B2; cyanocobalamin in an amount per eight ounce serving between 0.6 and 1.5 mg supplied through a complex between 0.75 and 1.88 mg; cholecalciferol in an amount per eight ounce serving between 40 and 100 IU or between 0.4 and 1 mg supplied through a complex; tocopheryl acetate in an amount per eight ounce serving between 3 and 7.5 IU or between 6 and 15 mg as a 50% Vitamin E complex; chromium in an amount per eight ounce serving between 12 and 30 mcg or between 1.2 and 3 mg as chromium picolinate; copper in an amount per eight ounce serving between 0.2 and 0.5 mg or between 1.43 and 3.575 mg as Copper Gluconate; Magnesium in an amount per eight ounce serving between 20 and 80 mg or between 149 and 596 mg as Magnesium Phosphate; Manganese in an amount per eight ounce serving between 0.2 and 0.5 mg or between 0.615 and 1.5375 mg as Manganese Sulfate; Selenium in an amount per eight ounce serving between 7 and 17.5 mcg or between 0.017 and 0.0425 mg as sodium Selenate; zinc in an amount per eight ounce serving between 1.5 and 3.8 mg or between 11.67 and 29.17 mg as Zinc Gluconate; and maltodextrin in a minor amount per eight ounce serving.

6. The composition of claim 2, wherein the added multi-vitamin and mineral component includes Beta Carotene in an amount per eight ounce fluid serving of between 100-1500 IU

7. The composition of claim 2, wherein the added multi-vitamin and mineral component includes Vitamin B5 in an amount per eight ounce fluid serving of between 0.2-3 mg.

8. The composition of claim 2, wherein the added multi-vitamin and mineral component includes Vitamin B3 in an amount per eight ounce fluid serving of between 0.4-6 mg.

9. The composition of claim 2, wherein the added multi-vitamin and mineral component includes Vitamin B6 in an amount per eight ounce fluid serving of between 0.04-0.6 mg.

10. The composition of claim 2, wherein the added multi-vitamin and mineral component includes Vitamin B2 in an amount per eight ounce fluid serving of between 0.034-0.51 mg

11. The composition of claim 2, wherein the added multi-vitamin and mineral component includes Vitamin B12 in an amount per eight ounce fluid serving of between 0.12-1.8 mg.

12. The composition of claim 2, wherein the added multi-vitamin and mineral component includes Vitamin D3 in an amount per serving of between 8-120 IU

13. The composition of claim 2, wherein the added multi-vitamin and mineral component includes Vitamin E in an amount per serving of between 0.6-9 IU.

14. The composition of claim 2, wherein the added multi-vitamin and mineral component includes Chromium in an amount per eight ounce fluid serving of between 2.4-36 mcg.

15. The composition of claim 2, wherein the added multi-vitamin and mineral component includes Copper in an amount per eight ounce fluid serving of between 0.04-0.6 mg.

16. The composition of claim 2, wherein the added multi-vitamin and mineral component includes Magnesium in an amount per eight ounce fluid serving of between 8-120 mg.

17. The composition of claim 2, wherein the added multi-vitamin and mineral component includes Manganese in an amount per eight ounce fluid serving of between 0.04-0.6 mg.

18. The composition of claim 2, wherein the added multi-vitamin and mineral component includes Selenium in an amount per eight ounce fluid serving of between 1.4-21 mcg.

19. The composition of claim 2, wherein the added multi-vitamin and mineral component includes and Zinc in an amount per eight ounce fluid serving of between 0.3-4.5 mg.
